(19) United States
(12) Patent Application Publication
(10) Pub. No.: US 2022/0198932 A1
(43) Pub. Date: Jun. 23, 2022

(54) INFORMATION PROCESSING APPARATUS, METHOD, AND SYSTEM

(71) Applicant: TOYOTA JIDOSHA KABUSHIKI KAISHA, Toyota-shi (JP)

(72) Inventors: Tetsushi Okamoto, Nisshin-shi (JP); Kazumi Aono, Gamagori-shi (JP); Naoki Uenoyama, Nagoya-shi (JP)

(73) Assignee: TOYOTA JIDOSHA KABUSHIKI KAISHA, Toyota-shi (JP)

(21) Appl. No.: 17/554,215

(22) Filed: Dec. 17, 2021

(30) Foreign Application Priority Data
Dec. 23, 2020 (JP) 2020-214248

(51) Int. Cl. G08G 1/00; G01C 21/34

(52) U.S. Cl. CPC G08G 1/202; G01C 21/3438

(57) ABSTRACT

An information processing apparatus includes a communication interface configured to communicate with a vehicle, and a controller configured to identify an area in which the vehicle can travel without supply of a power source, judge whether a first condition that a supply facility configured to supply the power source does not exist within the area is satisfied, and transmit an instruction to dispatch a supply vehicle configured to supply the power source when it is judged that the first condition is satisfied.

### CROSS-REFERENCE TO RELATED APPLICATION

This application claims priority to Japanese Patent Application No. 2020-214248, filed on Dec. 23, 2020, the entire contents of which are incorporated herein by reference.

### TECHNICAL FIELD

The present disclosure relates to an information processing apparatus, a method, and a system.

### BACKGROUND

Technology for supplying a power source to a vehicle is known. For example, patent literature (PTL) 1 discloses technology for displaying a gas station on a map when the remaining gasoline level of a vehicle reaches a predetermined value or less.

### CITATION LIST

### Patent Literature

PTL 1: JP H6-195594 A

### SUMMARY

There is room for improvement in technology for supplying a power source to a vehicle.

It would be helpful to improve technology for supplying a power source to a vehicle.

An information processing apparatus according to an embodiment of the present disclosure is an information processing apparatus that includes: a communication interface configured to communicate with a vehicle; and a controller configured to identify an area in which the vehicle can travel without supply of a power source, judge whether a first condition that a supply facility configured to supply the power source does not exist within the area is satisfied, and transmit an instruction to dispatch a supply vehicle configured to supply the power source when it is judged that the first condition is satisfied.

A method according to an embodiment of the present disclosure is a method to be executed by an information processing apparatus configured to communicate with a vehicle, the method including: identifying an area in which the vehicle can travel without supply of a power source, judging whether a first condition that a supply facility configured to supply the power source does not exist within the area is satisfied, and transmitting an instruction to dispatch a supply vehicle configured to supply the power source when it is judged that the first condition is satisfied.

A system according to an embodiment of the present disclosure is a system including a vehicle and an information processing apparatus configured to communicate with the vehicle, the information processing apparatus being configured to: identify an area in which the vehicle can travel without supply of a power source; judge whether a first condition that a supply facility configured to supply the power source does not exist within the area is satisfied; and transmit an instruction to dispatch a supply vehicle configured to supply the power source when it is judged that the first condition is satisfied.

According to an embodiment of the present disclosure, technology for supplying a power source to a vehicle is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2. illustrates an example of a vehicle and a travelable area;

FIG. 3 is a block diagram illustrating a schematic configuration of a vehicle;

FIG. 4 is a block diagram illustrating a schematic configuration of an information processing apparatus; and

FIG. 5 is a flowchart illustrating operations of an information processing apparatus.

### DETAILED DESCRIPTION

Hereinafter, an embodiment of the present disclosure will be described.

### Summary of Embodiment

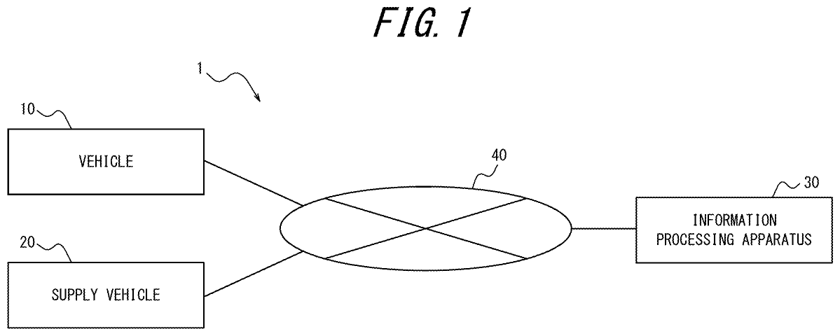

An outline of a system 1 according to an embodiment of the present disclosure will be described with reference to FIG. 1. The system 1 includes a vehicle 10, a supply vehicle 20, and an information processing apparatus 30. The vehicle 10, the supply vehicle 20, and the information processing apparatus 30 are communicably connected to a network 40 including, for example, the Internet, a mobile communication network, and the like.

The vehicle 10 is an automobile, for example, but is not limited to this, and may be any appropriate vehicle. The automobile may be a gasoline automobile, a BEV (Battery Electric Vehicle), an HEV (Hybrid Electric Vehicle), a PHEV (Plug-in Hybrid Electric Vehicle), a FCEV (Fuel Cell Electric Vehicle), or the like, but these examples are not limiting. The power source of the vehicle 10 may, for example, be gasoline, electricity, or hydrogen, but these examples are not limiting. The vehicle 10 may be capable of automated driving such as any one of Level 1 to Level 5 as defined by the Society of Automotive Engineers (SAE), for example. The number of vehicles 10 provided in the system 1 may be freely determined.

The supply vehicle 20 is an automobile provided with equipment for supplying a power source to the vehicle 10. Specifically, the supply vehicle 20 may have a space in which gasoline or hydrogen can be stored. The supply vehicle 20 can supply the gasoline or hydrogen stored in the space to the vehicle 10, for example via a hose. Alternatively, the supply vehicle 20 may have an energy storage apparatus capable of storing electrical energy. The supply vehicle 20 is capable of supplying electrical energy stored in the energy storage apparatus to the vehicle 10, for example in a wired or wireless manner. The supply vehicle 20 may be capable of automated driving such as any one of Level 1 to Level 5 as defined by the SAE, for example. The number of supply vehicles 20 provided in the system 1 may be freely determined.

The information processing apparatus 30 is, for example, a computer such as a server apparatus. The information processing apparatus 30 can communicate with each of the vehicle 10 and the supply vehicle 20 via the network 40.

First, an outline of the present embodiment will be described, and details thereof will be described later. The information processing apparatus 30 identifies an area in which the vehicle 10 can travel without supply of a power source (travelable area). The information processing apparatus 30 judges whether a first condition is satisfied. The first condition is that a supply facility (for example, gas station, charging station, or hydrogen station) configured to supply the power source does not exist within the travelable area. The information processing apparatus 30 then transmits an instruction to dispatch the supply vehicle 20 configured to supply the power source when it is judged that the first condition is satisfied.

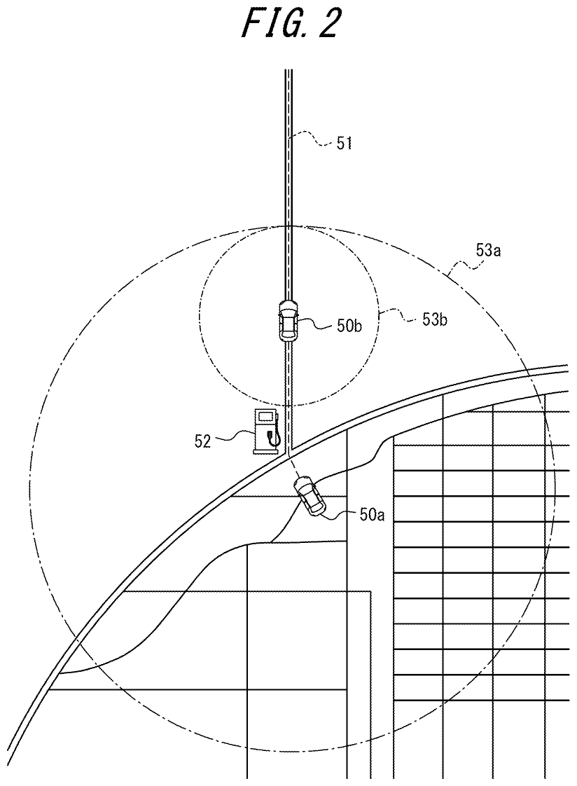

For example, FIG. 2 illustrates a travelable area 53 (53a) when the vehicle 10 is located at vehicle position 50 (50a) at time a. The shape of the travelable area 53 is, for example, a substantially circular shape centered on the vehicle position 50, but this example is not limiting. Here, a supply facility 52 is included in the travelable area 53a. Therefore, at time a, the aforementioned first condition that a supply facility 52 does not exist within the travelable area 53 is not satisfied. Accordingly, since the vehicle 10 has the power source necessary to travel to the supply facility 52, an opportunity remains at time a for the vehicle 10 to travel to the supply facility 52 by self- propulsion and receive supply of the power source.

Now consider the case where the vehicle 10 located at the vehicle position 50a at time a continues to travel along the travel route 51 without replenishing the power source at the supply facility 52. In FIG. 2, a travelable area 53 (53b) is illustrated for when the vehicle 10 is located at vehicle position 50 (50b) at time b, which is later than time a. Because the power source of the vehicle 10 is partially consumed between time a and time b, the travelable area 53b is smaller than the travelable area 53a at time a. Here, the supply facility 52 is not included in the travelable area 53b. Accordingly, at time b, the aforementioned first condition that a supply facility 52 configured to supply the power source does not exist within the travelable area 53 is satisfied. Since the vehicle 10 does not have the power source necessary to travel to the supply facility 52, no opportunity remains at time b for the vehicle 10 to travel to the supply facility 52 by self-propulsion and receive supply of the power source. Therefore, at a point in time later than time b, the vehicle 10 will be unable to continue traveling due to depletion of its power source.

To address this point in the present embodiment, an instruction to dispatch the supply vehicle 20 configured to supply the power source is transmitted when it is judged that the first condition is satisfied. The vehicle 10 can therefore meet the supply vehicle 20 dispatched based on the instruction and receive supply of the power source from the supply vehicle 20. Accordingly, technology for supplying a power source to the vehicle 10 is improved in that the vehicle 10 can receive supply of the power source from the dispatched supply vehicle 20 even in conditions such that the vehicle 10 has no remaining opportunity to travel to the supply facility 52 by self-propulsion and receive supply of the power source.

Next, configurations of the system 1 will be described in detail.

(Vehicle Configuration)

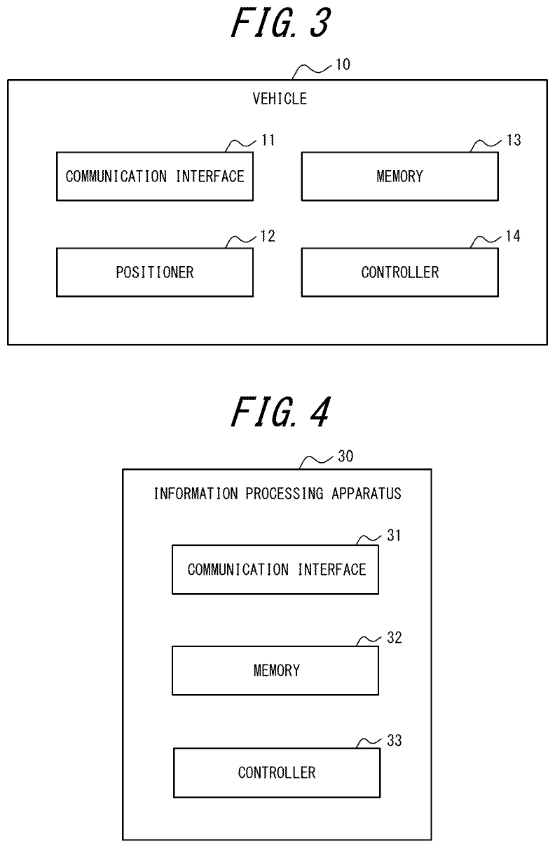

As illustrated in FIG. 3, the vehicle 10 includes a communication interface 11, a positioner 12, a memory 13, and a controller 14.

The communication interface 11 includes at least one communication interface for connecting to the network 40. The communication interface is compliant with mobile communication standards such as the 4th generation (4G) standard or the 5th generation (5G) standard, for example, but these examples are not limiting. In the present embodiment, the vehicle 10 communicates with the information processing apparatus 30 via the communication interface 11 and the network 40.

The positioner 12 includes one or more apparatuses configured to acquire positional information for the vehicle 10. Specifically, the positioner 12 includes, for example, a receiver compliant with GPS, but is not limited to this example and may include a receiver compliant with any appropriate satellite positioning system.

The memory 13 includes one or more memories. The memories are semiconductor memories, magnetic memories, optical memories, or the like, for example, but are not limited to these. The memories included in the memory 13 may each function as, for example, a main memory, an auxiliary memory, or a cache memory. The memory 13 stores any information used for operations of the vehicle 10. For example, the memory 13 may store a system program, an application program, embedded software, and the like. The information stored in the memory 13 may be updated with, for example, information acquired from the network 40 via the communication interface 11.

The controller 14 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 14 controls the operations of the entire vehicle 10.

(Supply Vehicle Configuration)

In addition to a similar configuration to the vehicle 10, the supply vehicle 20 is further provided with equipment for supplying a power source to vehicle 10. Such equipment include, for example, a space capable of storing gasoline or hydrogen, and an energy storage apparatus capable of storing electrical energy, as described above, although these examples are not limiting. A description of the configuration similar to that of the vehicle 10 is omitted.

(Information Processing Apparatus Configuration)

As illustrated in FIG. 4, the information processing apparatus 30 includes a communication interface 31, a memory 32, and a controller 33.

The communication interface 31 includes at least one communication interface for connecting to the network 40. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 30 communicates with each of the vehicle 10 and the supply vehicle 20 via the communication interface 31 and the network 40.

The memory 32 includes one or more memories. The memories included in the memory 32 may each function as, for example, a main memory, an auxiliary memory, or a cache memory. The memory 32 stores any information used in operation of the information processing apparatus 10. For example, the memory 32 may store a system program, an application program, a database, map information, and the like. The information stored in the memory 32 may be updated with, for example, information acquired from the network 40 via the communication interface 31.

The controller 33 includes at least one processor, at least one programmable circuit, at least one dedicated circuit, or a combination of these. The controller 33 controls operations of the entire information processing apparatus 30.

(Operation Flow in Information Processing Apparatus)

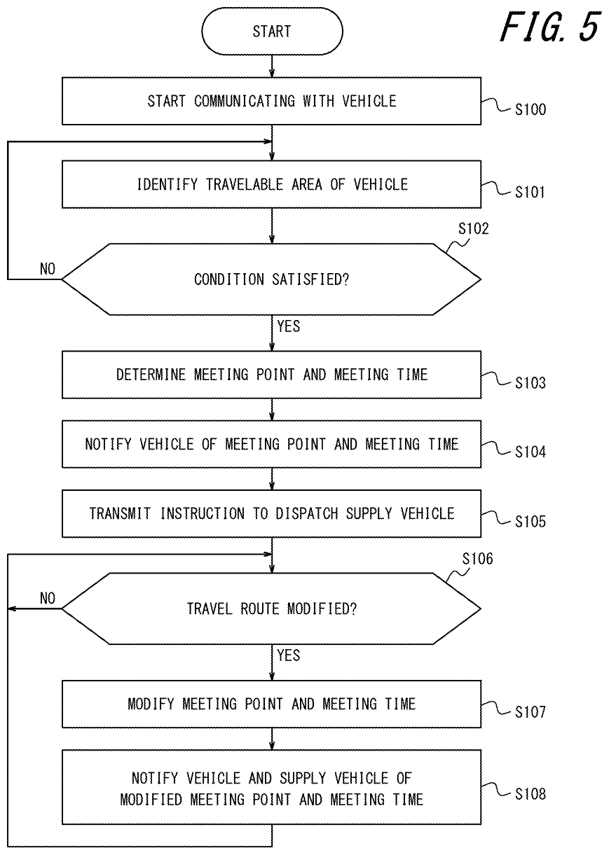

Operations of the information processing apparatus 30 according to the present embodiment will be described with reference to FIG. 5.

Step S100: The controller 33 of the information processing apparatus 30 starts communication with the vehicle 10 and the supply vehicle 20 via the communication interface 31 and the network 40.

Step S101: The controller 33 identifies a travelable area 53 in which the vehicle 10 can travel without supply of a power source.

Specifically, the controller 33 receives vehicle information from the vehicle 10 and identifies the travelable area 53 based on the vehicle information. The vehicle information for the vehicle 10 includes, for example, information indicating the type of power source of the vehicle 10 (such as gasoline, electricity, or hydrogen), remaining level of the power source, fuel efficiency, position, and travel route, although these examples are not limiting. For example, the vehicle information may include information indicating a driving tendency for the vehicle 10. The driving tendency may, for example, be a tendency to perform an operation that can improve or worsen the fuel efficiency of the vehicle 10. Non-limiting examples of operations that can improve fuel efficiency include shutting off the engine when the vehicle is stopped, or decelerating by engine braking. Non-limiting examples of operations that can worsen fuel consumption include rapid acceleration or deceleration due to depressing the accelerator or brake pedal. The controller 33 may, for example, correct information on the fuel efficiency based on the driving tendency of the vehicle 10.

In one example, the controller 33 calculates, based on the remaining level of the power source and the fuel efficiency, the distance that the vehicle 10 can travel without supply of the power source (travelable distance). The controller 33 identifies the travelable area 53 based on the positional information for the vehicle 10 and the travelable distance. The travelable area 53 may, for example, be a substantially circular area centered on the position of the vehicle 10 and having a radius of the travelable distance. The identification of the travelable area 53 is not, however, limited to the above example, and any appropriate method can be adopted.

Step S102: The controller 33 judges whether the first condition is satisfied. As described above, the first condition is that a supply facility 52 configured to supply the power source does not exist within the travelable area 53 determined in step S101. When it is judged that the first condition is satisfied (S102: Yes), the process advances to step S103. Conversely, when it is judged that the first condition is not satisfied (S102: No), the process returns to step S101.

Specifically, the controller 33 may refer to map information stored in the memory 32 to judge whether a supply facility 52 configured to supply the power source exists within the travelable area 53 identified in step S101. The controller 33 judges that the first condition is satisfied when a supply facility 52 does not exist within the travelable area 53. Conversely, the controller 33 judges that the first condition is not satisfied when a supply facility 52 exists within the travelable area 53.

As described above, the satisfaction of the first condition means that the vehicle 10 has no remaining opportunity to travel to the supply facility 52 by self-propulsion and receive supply of the power source. Accordingly, in the present embodiment, the supply vehicle 20 is dispatched, as described in detail below, when it is judged that the first condition is satisfied.

Step S103: When it is judged that the first condition is satisfied in step S102 (step S102: Yes), the controller 33 determines a meeting point and a meeting time at which the vehicle 10 and the supply vehicle 20 are to meet.

Here, when the system 1 includes a plurality of supply vehicles 20, for example, the controller 33 may receive vehicle information from each supply vehicle 20. The vehicle information for the supply vehicle 20 includes, but is not limited to, information indicating the type of power source that the supply vehicle 20 can supply (such as gasoline, electricity, or hydrogen), the stored volume or stored energy amount of the power source, the position of the supply vehicle 20, and the travel route, for example. Based on the vehicle information for the vehicle 10 and the plurality of supply vehicles 20, the controller 33 identifies, among the plurality of supply vehicles 20, a supply vehicle 20 that can supply the power source to the vehicle 10. For example, a supply vehicle 20 that has the same type of power source as the vehicle 10 and that has a stored volume or stored energy amount of at least a threshold can be identified.

The controller 33 then determines the meeting point and the meeting time based on the vehicle information for the vehicle 10 and the supply vehicle 20. The meeting point and the meeting time may, for example, be determined by a route search process based on the positional information for the vehicle 10 and the supply vehicle 20, but this example is not limiting, and the determination may be made by any appropriate method. The meeting point may, for example, be determined along a travel route of the vehicle 10. The earliest time at which both the vehicle 10 and the supply vehicle 20 can arrive at the determined meeting point may be determined as the meeting time.

Step S104: The controller 33 notifies the vehicle 10 of the meeting point and the meeting time determined in step S103. Upon receiving the notification of the meeting point and the meeting time, the controller 14 of the vehicle 10 may, for example, start travel route guidance or automatic driving with the meeting point as the destination and the meeting time as the arrival time at the destination.

Step S105: The controller 33 transmits an instruction to dispatch the supply vehicle 20 configured to supply the power source.

Specifically, the controller 33 transmits the instruction to the supply vehicle 20. The instruction may, for example, include information indicating the meeting point and the meeting time determined in step S103. The instruction may also include information indicating a travel route for the supply vehicle 20 such that the meeting point is the destination, and the meeting time is the arrival time at the destination. Upon receiving the instruction, the supply vehicle 20 may start travel route guidance or automatic driving with the meeting point as the destination and the meeting time as the arrival time at the destination.

Step S106: The controller 33 judges whether the travel route of the vehicle 10 has been modified. When it is judged that the travel route has been modified (step S106: Yes), the process advances to step S107. Conversely, when it is judged that the travel route has not been modified (step S106: No), the process repeats step S106.

Specifically, the controller 33 may, for example, judge that the travel route of the vehicle 10 has been modified upon receiving information indicating the modified travel route from the vehicle 10.

Step S107: When it is judged that the travel route of the vehicle 10 has been modified in step S106 (step S106: Yes), the controller 33 modifies the meeting point where the vehicle 10 and the supply vehicle 20 are to meet and the meeting time.

Specifically, the controller 33 modifies the meeting point and the meeting time based on the information indicating the modified travel route of the vehicle 10 and the positional information for the vehicle 10 and the supply vehicle 20. The modified meeting point and the meeting time may, for example, be determined by a route search process based on the positional information for the vehicle 10 and the supply vehicle 20, but this example is not limiting, and the determination may be made by any appropriate method. The modified meeting point may, for example, be determined along the modified travel route of the vehicle 10. The earliest time at which both the vehicle 10 and the supply vehicle 20 can arrive at the modified meeting point may be determined as the modified meeting time.

Step S108: The controller 33 notifies the vehicle 10 and the supply vehicle 20 of the modified meeting point and meeting time. Upon receiving the notification of the modified meeting point and meeting time, the respective controllers 14 of the vehicle 10 and the supply vehicle 20 may, for example, start travel route guidance or automatic driving with the modified meeting point as the destination and the modified meeting time as the arrival time at the destination. The process subsequently returns to step S106.

As described above, the information processing apparatus 30 according to the present embodiment identifies a travelable area 53 in which the vehicle 10 can travel without supply of a power source. The information processing apparatus 30 judges whether the first condition that the supply facility 52 configured to supply the power source does not exist within the travelable area 53 is satisfied. The information processing apparatus 30 then transmits an instruction to dispatch the supply vehicle 20 configured to supply the power source when it is judged that the first condition is satisfied.

According to this configuration, an instruction to dispatch a supply vehicle 20 configured to supply the power source is transmitted when it is judged that the first condition is satisfied. The vehicle 10 can therefore meet the supply vehicle 20 dispatched based on the instruction and receive supply of the power source from the supply vehicle 20. Accordingly, technology for supplying a power source to the vehicle 10 is improved in that the vehicle 10 can receive supply of the power source from the dispatched supply vehicle 20 even in conditions such that the vehicle 10 has no remaining opportunity to travel to the supply facility 52 by self-propulsion and receive supply of the power source.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 30 in the above embodiment are distributed to a plurality of computers capable of communicating with each other can also be implemented. For example, an embodiment in which some or all of the components of the information processing apparatus 30 are provided in the vehicle 10 and the supply vehicle 20 can also be implemented.

In the above embodiment, when the vehicle 10 approaches an intersection in a state in which the first condition is not satisfied, the controller 33 of the information processing apparatus 30 may estimate the direction of travel of the vehicle 10 at the intersection and transmit the instruction to dispatch the supply vehicle 20 when a second condition that a supply facility 52 does not exist within the travelable area 53 in the direction of travel is satisfied.

Any appropriate method can be adopted to judge whether the second condition is satisfied. For example, consider the case in which the vehicle 10 is approaching an intersection. It is assumed that within the travelable area 53 of the vehicle 10, a supply facility 52 configured to supply the power source exists ahead after turning right or left at the intersection, but a supply facility 52 does not exist ahead after traveling straight through the intersection. The first condition is not satisfied, because a supply facility 52 is located within the travelable area 53. In this case, if the vehicle 10 is located in a straight-only lane before the intersection, and the vehicle 10 continues to travel, there may no longer be a supply facility 52 in the travelable area 53 as a result of the vehicle 10 traveling straight through the intersection instead of towards the supply facility 52. To address this, when the vehicle 10 approaches an intersection in a state in which the first condition is not satisfied, the controller 33 estimates the direction of travel (such as straight ahead, left turn, or right turn) of the vehicle 10 at the intersection based on the lane in which the vehicle 10 is located or travel route information for the vehicle 10, for example. The controller 33 judges whether the second condition that a supply facility 52 does not exist within the travelable area 53 in the estimated direction of travel is satisfied. The controller 33 transmits the instruction to dispatch the supply vehicle 20 when judging that the second condition is satisfied.

In the above embodiment, an example is described in which the controller 33 of the information processing apparatus 30 transmits the instruction to dispatch the supply vehicle 20 to the supply vehicle 20. However, the controller 33 may transmit the instruction to a management server or the like that manages the operation of the supply vehicle 20 instead of to the supply vehicle 20.

For example, an embodiment in which a general purpose computer functions as the information processing apparatus 30 according to the above embodiment can also be implemented. Specifically, a program in which processes for realizing the functions of the information processing apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a communication interface configured to communicate with a vehicle and a controller configured to:
identify an area in which the vehicle can travel without supply of a power source;
judge whether a first condition that a supply facility configured to supply the power source does not exist within the area is satisfied; and
transmit an instruction to dispatch a supply vehicle configured to supply the power source when it is judged that the first condition is satisfied.

2. The information processing apparatus of claim 1, wherein the controller is configured to notify the vehicle of information indicating that the first condition is satisfied when it is judged that the first condition is satisfied.

3. The information processing apparatus of claim 1, wherein
the controller is configured to determine a meeting point where the vehicle and the supply vehicle are to meet on a travel route of the vehicle, and
the instruction includes information indicating the meeting point.

4. The information processing apparatus of claim 3, wherein the controller is configured to notify the vehicle of the meeting point when the meeting point is determined.

5. The information processing apparatus of claim 3, wherein
when the travel route of the vehicle is modified after the instruction is transmitted, the controller is configured to modify the meeting point based on the modified travel route, and
the controller is configured to notify the vehicle and the supply vehicle of the modified meeting point.

6. The information processing apparatus of claim 1, wherein
when the vehicle approaches an intersection in a state in which the first condition is not satisfied, the controller is configured to estimate a direction of travel of the vehicle at the intersection, and
the controller is configured to transmit the instruction to dispatch the supply vehicle when a second condition that the supply facility does not exist within the area in the direction of travel is satisfied.

7. The information processing apparatus of claim 1, wherein
the controller is configured to determine a meeting time when the vehicle and the supply vehicle are to meet,
the controller is configured to notify the vehicle of the meeting time, and
the instruction includes information indicating the meeting time.

8. A method to be executed by an information processing apparatus configured to communicate with a vehicle, the method comprising:
identifying an area in which the vehicle can travel without supply of a power source,
judging whether a first condition that a supply facility configured to supply the power source does not exist within the area is satisfied, and
transmitting an instruction to dispatch a supply vehicle configured to supply the power source when it is judged that the first condition is satisfied.

9. The method of claim 8, further comprising notifying the vehicle of information indicating that the first condition is satisfied when it is judged that the first condition is satisfied.

10. The method of claim 8, further comprising
determining a meeting point where the vehicle and the supply vehicle are to meet on a travel route of the vehicle, wherein
the instruction includes information indicating the meeting point.

11. The method of claim 10, further comprising notifying the vehicle of the meeting point when the meeting point is determined.

12. The method of claim 10, further comprising
modifying, when the travel route of the vehicle is modified after the instruction is transmitted, the meeting point based on the modified travel route; and
notifying the vehicle and the supply vehicle of the modified meeting point.

13. The method of claim 8, further comprising
estimating, when the vehicle approaches an intersection in a state in which the first condition is not satisfied, a direction of travel of the vehicle at the intersection; and
transmitting the instruction to dispatch the supply vehicle when a second condition that the supply facility does not exist within the area in the direction of travel is satisfied.

14. The method of claim 8, further comprising
determining a meeting time when the vehicle and the supply vehicle are to meet; and
notifying the vehicle of the meeting time, wherein
the instruction includes information indicating the meeting time.

15. A system comprising a vehicle and an information processing apparatus configured to communicate with the vehicle, the information processing apparatus being configured to:
identify an area in which the vehicle can travel without supply of a power source;
judge whether a first condition that a supply facility configured to supply the power source does not exist within the area is satisfied; and
transmit an instruction to dispatch a supply vehicle configured to supply the power source when it is judged that the first condition is satisfied.

16. The system of claim 15, wherein the information processing apparatus is configured to notify the vehicle of information indicating that the first condition is satisfied when it is judged that the first condition is satisfied, and the vehicle is configured to output the notified information.

17. The system of claim 15, wherein
the vehicle is configured to notify the information processing apparatus of a travel route of the vehicle,
the information processing apparatus is configured to determine a meeting point where the vehicle and the supply vehicle are to meet on the travel route of the vehicle, and
the instruction includes information indicating the meeting point.

18. The system of claim 17, wherein
the information processing apparatus is configured to notify the vehicle of the meeting point when the meeting point is determined, and
the vehicle is configured to output information indicating the notified meeting point.

19. The system of claim 17, wherein
when the travel route of the vehicle is modified, the vehicle is configured to notify the information processing apparatus of the modified travel route,
when the travel route of the vehicle is modified after the instruction is transmitted, the information processing apparatus is configured to modify the meeting point based on the modified travel route, and
the information processing apparatus is configured to notify the vehicle and the supply vehicle of the modified meeting point.

20. The system of claim 15, wherein
when the vehicle approaches an intersection in a state in which the first condition is not satisfied, the information processing apparatus is configured to estimate a direction of travel of the vehicle at the intersection, and
the information processing apparatus is configured to transmit the instruction to dispatch the supply vehicle when a second condition that the supply facility does not exist within the area in the direction of travel is satisfied.
